(19) United States
(12) Patent Application Publication
(10) Pub. No.: US 2025/0220663 A1
(43) Pub. Date: Jul. 3, 2025

(54) Secondary Channel Access During Bursts of Beacons and Groupcast

(71) Applicant: Cisco Technology, Inc., San Jose, CA (US)

(72) Inventors: Brian D. Hart, Sunnyvale, CA (US); Matthew A. Silverman, Shaker Heights, OH (US)

(73) Assignee: Cisco Technology, Inc., San Jose, CA (US)

(21) Appl. No.: 18/751,263

(22) Filed: Jun. 23, 2024

Related U.S. Application Data
(60) Provisional application No. 63/616,562, filed on Dec. 30, 2023.

(51) Int. Cl. H04W 72/121; H04L 5/00; H04W 84/12

(52) U.S. Cl. CPC H04W 72/121; H04L 5/0055; H04W 84/12

(57) ABSTRACT

Enabling secondary channel access during beacon and groupcast traffic and shortening the periods of beacon and groupcast traffic may be provided. Enabling secondary channel access can include advertising a capability to exchange traffic on secondary channels during beacon period. During a beacon period, beacons and groupcast traffic are transmitted on a primary channel and traffic is exchanged with the one or more clients on one or more secondary channels. Enabling secondary channel access between OBSSs can include one BSS transmitting beacons and groupcast traffic on a primary channel and another BSS exchanging traffic on secondary channels. Shortening beacon periods can include offsetting or otherwise organizing Delivery Traffic Indication Map (DTIM) beacons and groupcast traffic.

### RELATED APPLICATION

Under provisions of 35 U.S.C. § 119(e), Applicant claims the benefit of and priority to U.S. Provisional Application No. 63/616,562, filed Dec. 30, 2023, the disclosure of which is incorporated herein by reference in its entirety.

### TECHNICAL FIELD

The present disclosure relates generally to enabling secondary channel access during beacon and groupcast traffic and shortening the periods of beacon and groupcast traffic.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for secondary channel access during beacon and groupcast traffic;

FIG. 2 is a block diagram of a first signal process for shortening the periods of beacon and groupcast traffic;

FIG. 3 is a block diagram of a second signal process for VAPs in the same AP 102 or non-co-located Basic Service Sets (BSSs) to use secondary channel access during beacon and groupcast traffic;

FIG. 4 is a block diagram of a third signal process for reducing latency of Downlink (DL) traffic using secondary channel access during beacon and groupcast traffic;

FIG. 5 is a block diagram of a fourth signal process for reducing latency of Uplink (UL) and DL traffic using secondary channel access during beacon and groupcast traffic;

FIG. 6 is a flow chart of a method for enabling secondary channel access during beacon and groupcast traffic; and

FIG. 7 is a block diagram of a computing device.

### DETAILED DESCRIPTION

### Overview

Enabling secondary channel access during beacon and groupcast traffic and shortening the periods of beacon and groupcast traffic may be provided. Enabling secondary channel access can include advertising a capability to exchange traffic on secondary channels during beacon period. During a beacon period, beacons and groupcast traffic are transmitted on a primary channel and traffic is exchanged with the one or more clients on one or more secondary channels.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In existing networking implementations, it can be difficult to exchange traffic within strict Quality of Service (QOS) latency requirements (e.g., a latency requirement of less than three milliseconds) in the presence of beacon and groupcast traffic. Beacons may be relatively short transmissions meant to inform client devices about available services, nearby Access Points (APs), and/or other information associated with the network. Groupcast traffic comprises group addressed (e.g., broadcast or multicast) data and/or management frames that are each transmitted in the BSS and addressed to a group of recipients. In embodiments herein, the groupcast traffic may be Delivery Traffic Indication Map (DTIM) groupcast traffic. DTIM is a type of beacon that can inform client devices about the presence of buffered groupcast traffic. One beacon for every DTIM period (e.g., for Beacon Period=1, 2 . . . ) may be a DTIM beacon. A DTIM beacon is a type of beacon that can inform client devices about the imminent transmission of buffered groupcast traffic, since any buffered groupcast frames (DTIM groupcast) is sent almost immediately after each DTIM beacon.

An AP configured with multiple Service Set Identifiers (SSIDs) can transmit beacons (e.g., including DTIM beacons to announce groupcast traffic) for multiple Virtual APs (VAPs), and the beacons are typically sent in a Short Interframe Space (SIFS)-separated sequence. The AP will then immediately transmit the groupcast traffic after transmitting the beacons when the beacons are DTIM beacons. On the 2.4 Gigahertz (GHz) and 5 GHz bands, the AP may transmit multiple Basic SSID (BSSID) beacons at a time. On the 6 GHz band, the AP may transmit a plurality of Multiple BSSID (MBSSID) beacons at a time.

Because an AP may transmit beacons in a SIFS-separated sequence immediately followed by transmitting groupcast traffic, the AP may not transmit other data traffic while transmitting beacons and groupcast. Therefore, the transmission of the beacons and groupcast can last long enough (e.g., of the order of one millisecond, two milliseconds, and even five milliseconds, etc.) that the AP fails to meet QoS latency requirements for the other data traffic. Systems and methods are described herein to enable secondary channel access during beacon and groupcast transmissions and/or to shorten the periods during which the AP is transmitting beacon and/or groupcast traffic to allow the AP to meet the QoS latency requirements for other data traffic.

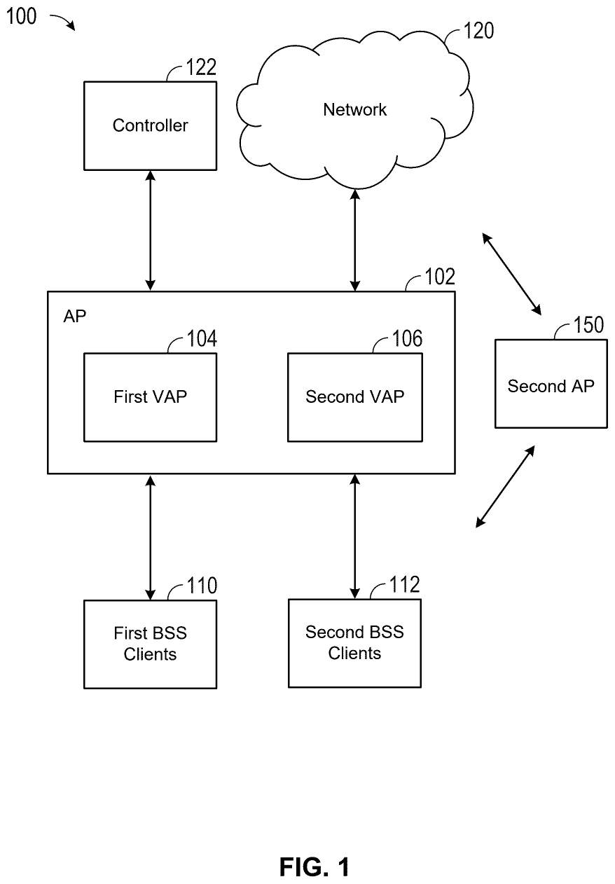

FIG. 1 is a block diagram of an operating environment 100 for secondary channel access during beacon and groupcast traffic. The operating environment 100 may include an AP 102 with a first VAP 104 and a second VAP 106, first Basic Service Set (BSS) clients 110, second BSS clients 112, a network 120, and a controller 122. The AP 102 may enable devices, such as the first BSS clients 110 and the second BSS clients 112, to connect to the network 120. The first VAP 104 and the second VAP 106 may be multiplexed installations or logical entities of multiple APs. Thus, the AP 102 presents itself as multiple APs via the first VAP 104 and the second VAP 106. The first VAP 104 and the second VAP 106 may each have an associated BSSID.

The first BSS clients 110 and the second BSS clients 112 can be any devices that connects to the network 120 to communicate with other devices on the network 120, such as a smart phone, a tablet, a personal computer, a server, and/or the like. The first BSS clients 110 may be associated with a BSSID of the first VAP 104, and the second BSS Clients 112 may be associated with a BSSID of the second VAP 106. The first BSS clients 110 and the second BSS clients 112 may be positioned anywhere in range of the AP 102.

The controller 122 may be any network controller (e.g., a Wireless Local Area Network (WLAN) controller) and may manage the AP 102 and/or other network devices to allow wireless devices to connect to the network 120. The operations of the controller 122 may be performed by the AP 102 in some embodiments and vice versa. The operating environment 100 is an example configuration and there may be a different number of APs, VAPs of each AP, controllers, clients, and/or other devices in further examples. In some embodiments, the signal processes and methods described herein may include one or more physical APs rather than VAPs.

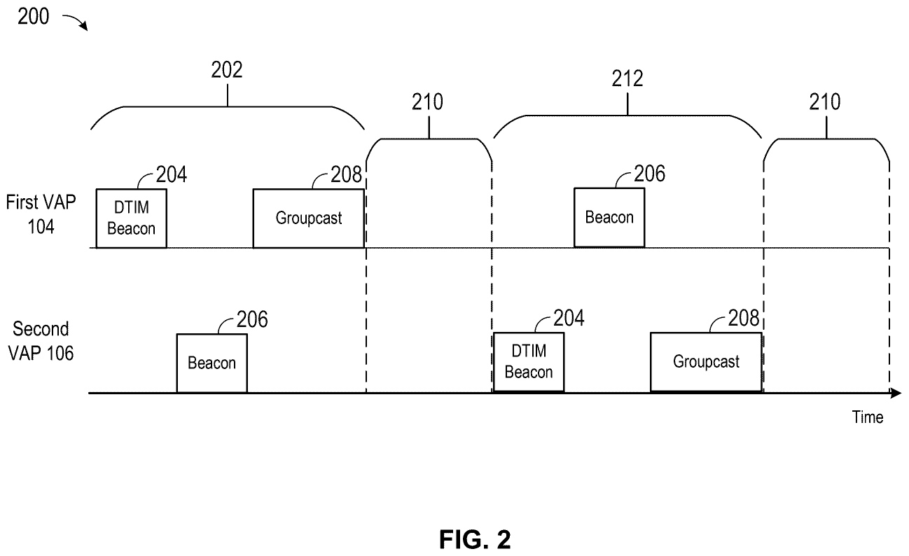

Shortening the beacon periods (i.e., the time a device is transmitting beacons) to alleviate issues with tight latency requirement traffic can include the AP 102 and/or the controller 122 offsetting or otherwise organizing the first VAP 104, the second VAP 106, and/or the like so a minimum number of VAPs and/or APs are transmitting DTIM beacons and associated groupcast traffic per beacon period. With a minimum number of VAPs and/or APs are transmitting DTIM beacons and associated groupcast traffic per beacon period, each beacon period will be shorter than a beacon period with more DTIM beacons and associated groupcast traffic. Shortening the beacons periods is described in more detail herein with respect to FIG. 2.

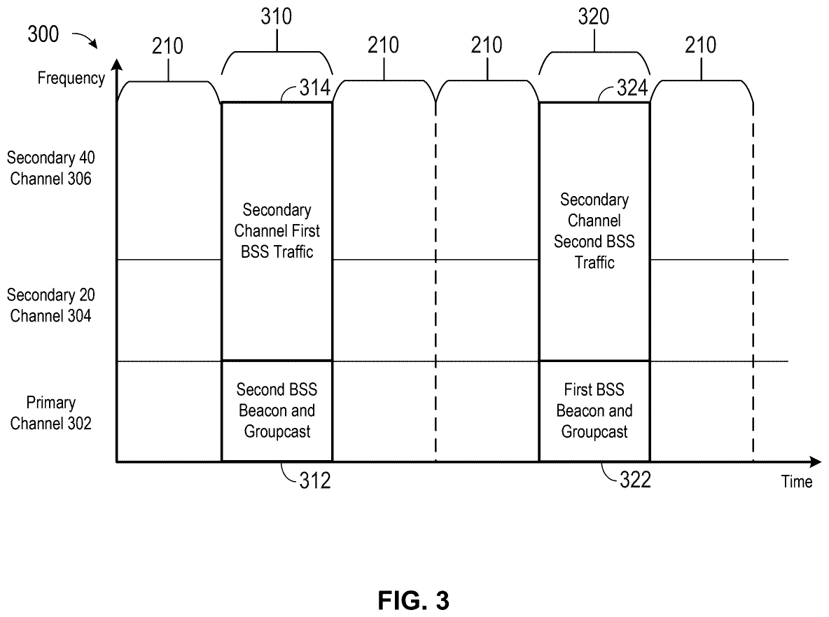

Enabling secondary channel access during beacon periods can be performed between Basic Service Sets (BSSs), including Overlapping BSSs (OBSSs). For example, the operating environment 100 can include a second AP 105. The AP 102 may be associated with a first BSS, and the second AP 150 may be associated with a second BSS overlapping the first BSS. In other examples, the first VAP 104 may be associated with the first BSS, and the second VAP 106 may be associated with the second BSS. When the AP 102 transmits beacons and groupcast traffic on a primary channel, the device associated with the second BSS may exchange traffic with clients of the second BSS using secondary channels. Similarly, when the device associated with the second BSS transmits beacons and groupcast traffic on a primary channel, the AP 102 may exchange traffic with clients of the first BSS using secondary channels. Enabling secondary channel access between BSSs such as OBSSs is described in more detail herein with respect to FIG. 3.

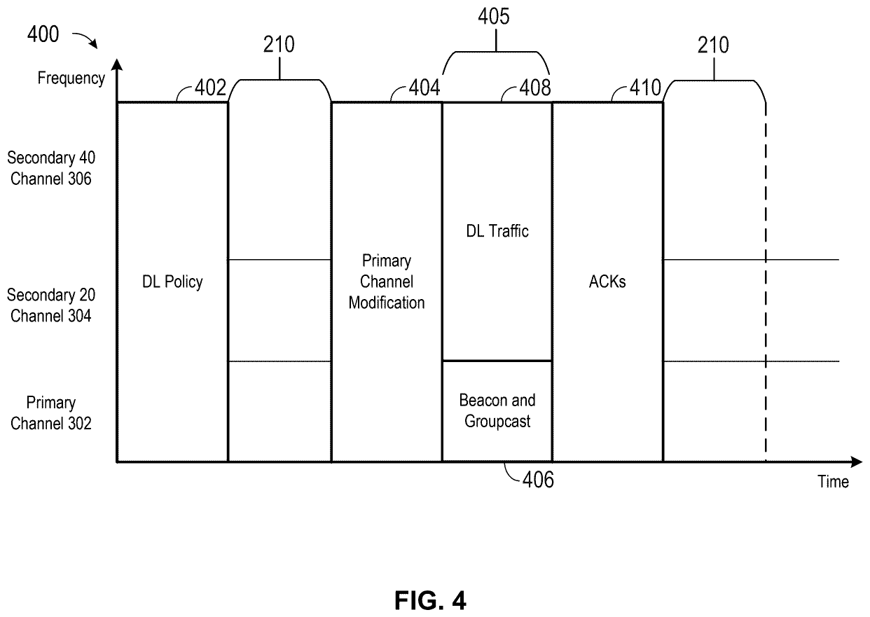

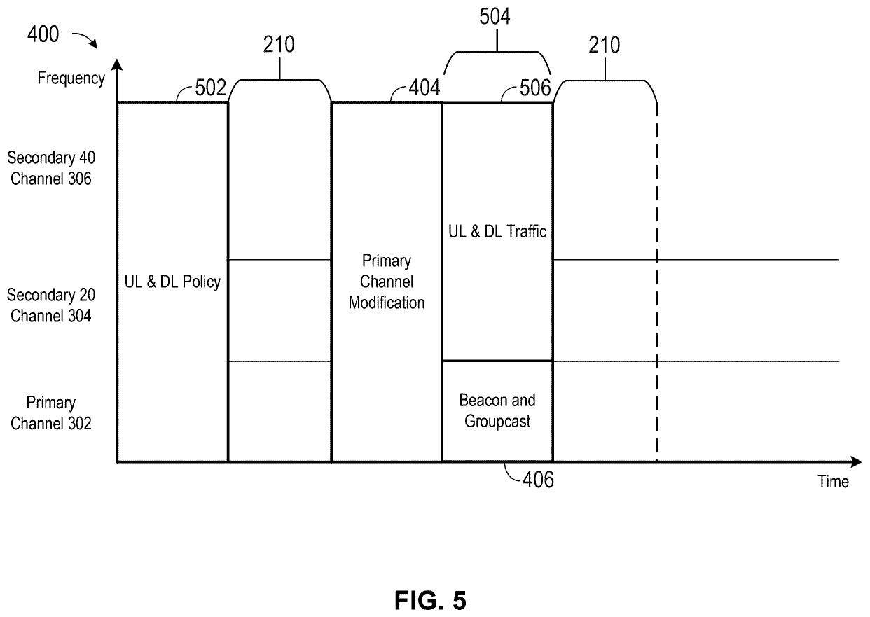

Secondary channel access during beacon periods can be performed by an AP, such as the AP 102. In some embodiments, the AP 102 can send beacons and groupcast traffic on a primary channel and Downlink (DL) traffic on secondary channels. In other embodiments, the AP 102 can send beacons and groupcast traffic on a primary channel and Uplink (UL) and/or DL traffic on secondary channels. Enabling secondary channel access during beacon periods by the AP 102 is described in more detail herein with respect to FIG. 4 and FIG. 5.

FIG. 2 is a block diagram of a first signal process 200 for shortening the periods of beacon and groupcast traffic. In previously existing implementations, DTIM beacons for any number of BSSIDs (i.e., VAPs) may be allowed for any beacon period (i.e., the period of beacon bursts and any groupcast traffic). However, allowing multiple VAPs to send DTIM beacons and groupcast traffic during a single beacon period may cause the length of that beacon period to be too long to accommodate traffic with tight QoS latency requirements. Therefore, the first signal process 200 includes the AP 102 offsetting or otherwise limiting which VAPs can send DTIM beacons and groupcast traffic per beacon period.

Offsetting the VAPs can include minimizing the number of VAPs that will send DTIM beacons and groupcast traffic per beacon burst. Therefore, a single VAP would send DTIM beacons and groupcast traffic per beacon burst when possible. IF there is only one VAP, the one VAP can send DTIM beacons and groupcast traffic at any time. However, when there are more VAPs than beacon periods each VAP needs to consistently use (e.g., each VAP needs to send a DTIM and groupcast traffic every three beacon periods but there are four VAPs), multiple VAPs may transmit DTIM beacons and groupcast traffic per beacon burst. However, the AP 102 may still offset the VAPs so no beacon period includes more VAPs transmitting DTIM beacons and groupcast traffic per beacon burst than necessary. For instance, if there are three VAPs and the DTM period is four, then the AP 102 may cause the second VAP to transmit its DTIM Beacons one beacon interval later than the first VAP and cause the third VAP to transmit its DTIM Beacons one beacon interval later than the second VAP.

The AP 102 may set a DTIM interval to define when a VAP needs to send DTIM beacons and groupcast traffic (e.g., every four beacon intervals, every five beacon intervals, and/or the like), for example based on traffic, network characteristics, and/or the like. For M number of VAPs needing to send DTIM beacons and groupcast traffic every Nth beacon period (i.e., wherein Nis defined by the DTIM interval), the VAPs transmitting DTIM beacons and groupcast traffic may comprise the largest integer greater than or equal to M divided by N minus one or the largest integer greater than or equal to M divided by N worth of groupcast. For example, if M is equal to N, then the beacon burst is followed by a single VAP's groupcast.

To reduce the length of beacon intervals for VAPs with the same DTIM, such as the first VAP 104 and the second VAP 106, the AP 102 may start or otherwise enable the VAPs at different times. For example, when the AP 102 initiates the first VAP 104 and the second VAP 106, the AP 102 may start each new VAP at one beacon period after the previous VAP started. Offsetting the initialization or start time of the VAPs may cause the VAPs to transmit any DTIM beacons and groupcast traffic during the first beacon period the VAP is active, so the VAPs may not transmit DTIM beacons and groupcast traffic during the same beacon period. Additionally, when the AP 102 starts a new VAP given a pre-existing collection of VAPs, the AP 102 may start the new VAP so the VAP will transmit DTIM beacons and groupcast traffic during the beacon period cycle with the fewest number of DTIM beacons from the pre-existing collection of VAPs.

The first signal process 200 illustrates the offsetting of the first VAP 104 and the second VAP 106 for different beacon period to reduce the beacon interval length of each beacon period. The first signal process 200 includes a first beacon period 202. The AP 102 may offset the first VAP 104 and the second VAP 106 so only the first VAP 104 can exchange groupcast traffic during the first beacon period 202. In the first beacon period 202, the first VAP 104 may transmit one or more DTIM beacons 204. The first VAP 104 may have a BSSID associated with the first BSS clients 110. Therefore, the DTIM beacons 204 of the first beacon period 202 may indicate that the first BSS clients 110 will receive groupcast traffic during the first beacon period 202.

Because the AP 102 offset the first VAP 104 and the second VAP 106 so only the first VAP 104 can transmit groupcast traffic during the first beacon period 202, the second VAP 106 may not send DTIM beacons during the first beacon period 202. However, the second VAP 106 may send beacons 206 during the first beacon period 202. The beacons 206 may be any non-DTIM beacons the second VAP 106 determines to send, such as beacons indicating information about the network 120 and/or devices associated with the network including the AP 102.

The first VAP 104 may then transmit groupcast traffic 208 during the first beacon period 202. In example implementations, the first VAP 104 transmits groupcast traffic 208 to the first BSS clients 110. After the first beacon period 202, there may be a traffic period 210. The first VAP 104 and/or the second VAP 106 can exchange traffic with clients during the traffic period 210 (e.g., tight latency requirement traffic). Because only the first VAP 104 transmitted DTIM beacons 204 and groupcast traffic 208, the traffic period 210 may occur soon enough to meet the latency requirements of traffic exchanged during the traffic period 210.

There may be a second beacon period 212 after the traffic period 210. The AP 102 may offset the first VAP 104 and the second VAP 106 so only the second VAP 106 can transmit groupcast traffic during the second beacon period 212. For example, the AP 102 may start or otherwise initialize the first VAP 104 at the first beacon period 202 and start or otherwise initialize the second VAP 106 at the second beacon period 212. In the second beacon period 212, the second VAP 106 may transmit one or more DTIM beacons 204. The second VAP 106 may have a BSSID associated with the second BSS clients 112. Therefore, the DTIM beacons 204 of the second beacon period 212 may indicate that the second BSS clients 112 will receive groupcast traffic during the second beacon period 212.

Because the AP 102 offset the first VAP 104 and the second VAP 106 so only the second VAP 106 can exchange groupcast traffic during the second beacon period 212, the first VAP 104 may not send DTIM beacons during the second beacon period 212. However, the first VAP 104 may send beacons 206 during the second beacon period 212. The beacons 206 may be beacons indicating information about the transmitting VAP (104 or 106), the network 120, and/or devices associated with the network including Virtual AP MLDs such as might be contained in the AP 102.

The second VAP 106 may then exchange groupcast traffic 208 during the second beacon period 212. In example implementations, the second VAP 106 exchanges groupcast traffic 208 with the second BSS clients 112. After the second beacon period 212, there may be another traffic period 210. Because only the second VAP 106 transmitted DTIM beacons 204 and groupcast traffic 208, the traffic period 210 may occur soon enough to meet the latency requirements of traffic exchanged during the traffic period 210 after the second beacon period 212.

In some example implementations, the AP 102 may set the VAPs to transmit DTIM beacons according to relatively prime numbers so the DTIM beacons typically do not align in a beacon period. For example, when the DTIM periods of four VAPs are assigned to the prime numbers two, three, five, and seven, then the four VAP DTIM beacons will align every two hundred and ten beacon periods. Thus, a majority of the beacon periods may be short enough to allow the AP 102 to meet tight latency requirements for other traffic.

FIG. 3 is a block diagram of a second signal process 300 for VAPs in the same AP or non-co-located BSSs to use secondary channel access during beacon and groupcast traffic. The second signal process 300 may illustrate the signals exchanged between APs (e.g., including VAPs) and clients with the x-axis variable being time and the y-axis variable being frequency. For example, the second signal process 300 may include the first VAP 104 associated with one BSS and the second VAP 106 associated with a second BSS in some embodiments. In other embodiments, the second signal process 300 may include the AP 102 associated with a first BSS and another physical AP associated with a second BSS overlapping with the first BSS. The y-axis includes a primary channel 302, a secondary 20 channel 304 (e.g., a secondary 20 MHz channel), and a secondary 40 channel 306 (e.g., a secondary 40 MHz channel). The primary channel 302, the secondary 20 channel 304, and the secondary 40 channel 306 may be any channels, and the configuration of the channels may vary in other embodiments.

When BSSs have the same primary channel 302, the secondary channels (e.g., the secondary 20 channel 304, the secondary 40 channel 306, and/or the like) may be available when one of the APs or VPAs of one of a first BSS of the group of BSSs is sending beacons and groupcast on the primary channel 302. Thus, the secondary channels may be used by one or more other BSSs of this AP 102 or BSSs of different AP devices (i.e., OBSSs) for exchanging traffic during the beacon period of the first BSS.

Beacon burst schedules may be predictable, so the AP 102 and/or other APs associated with BSSs with respect to the AP transmitting the beacon burst may schedule the secondary-channel TxOps in advance. Scheduling the TxOps may inform the associated client of when TxOps on the non-primary channel will occur, therefore removing ambiguity for the associated clients. In some embodiments, the APs or VAPs can use Coordinated-Orthogonal Frequency-Division Multiple Access (C-OFDMA), Coordinated-Orthogonal Frequency-Division Multiplexing (C-OFDM), or pseudo-C-OFDM during the secondary-channel TxOps to increase efficiency. Pseudo-C-OFDM can include two independent Physical Layer Protocol Data Units (PPDUs) sent by the same transmitter (i.e., with no cross-signaling) that ideally have identical durations and OFDM symbol durations to minimize adjacent channel interference, but also the different PPDUs can use a low MCS to tolerate some cross-interference and/or some guard band can be included between the two PPDUs. The following table describes example implementations of pseudo-OFDM and C-OFDMA.

Variant

| | | |
|---|---|---|
| One AP device, | Beacon burst in legacy | Pseudo-C-OFDM |
| one VAP | PPDU(s) on primary. | |
| | Clients also told | |
| | to look for other | |
| | frames in PPDUs on | |
| | secondary channels, with | |
| | the PPDUs' OFDM | |
| | symbol periods aligned as | |
| | much as possible else | |
| | FDM with some guard | |
| | band between. | |
| One AP device, | One VAP sends Beacon | Pseudo-C-OFDM |
| two VAPs | burst in legacy PPDU(s) | |
| | on primary. The clients of | |
| | the other VAP(s) are told | |
| | to look for other frames in | |
| | PPDUs on secondary | |
| | channels, with the | |
| | PPDUs' OFDM symbol | |
| | periods aligned as much | |
| | as possible else FDM with | |
| | some guard band | |
| | between. | |
| Two AP devices, | The VAP(s) of one | C-OFDMA |
| each AP has a | AP device's radio | |
| radio, and each | sends Beacon | |
| radio has one | burst in legacy | |
| or more VAPs | PPDU(s) on primary, the | |
| | VAP(s) of the other AP | |
| | device's radio tell their | |
| | clients to look for other | |
| | frames in PPDUs on | |
| | secondary channels. | |

The second signal process 300 can start with a traffic period 210. During the traffic period 210, the AP 102 (e.g., the first VAP 104) or another device associated with a first BSS may send a signal to schedule a TxOp on secondary channels (e.g., the secondary 20 channel 304, the secondary 40 channel 306, and/or the like) with clients of the first BSS (e.g., the first BSS clients 110). A second BSS beacon period 310 may then occur during the second signal process 300. During the second BSS beacon period 310, a device (e.g., the second VAP 106) associated with the second BSS that overlaps with the first BSS or is a BSS of VAPs of the same AP may perform second BSS beacons and groupcast signaling 312 on the primary channel 302. The second BSS beacons and groupcast signaling 312 can include DTIM beacons, non-DTIM beacons, and groupcast traffic the device associated with the second BSS sends to the second BSS clients 112. The device associated with the first BSS may exchange traffic with clients of the first BSS via first BSS traffic signaling 314 during the second BSS beacon period 310 on the secondary 20 channel 304 and the secondary 40 channel 306. The first BSS traffic signaling 314 can include traffic that the device associated with the first BSS would transmit to the first BSS clients 110 outside of a beacon period, such as latency sensitive traffic. Thus, the first BSS clients 110 may receive traffic without interruption during the second BSS beacon period 310.

One or more traffic periods 210 may occur after the second BSS beacon period 310. The device associated with the second BSS may send a signal to schedule a TxOp on secondary channels (e.g., the secondary 20 channel 304, the secondary 40 channel 306, and/or the like) with the second BSS clients 112 during the one or more traffic periods 210. A first BSS beacon period 320 may then occur during the second signal process 300. During the first BSS beacon period 320, the device associated with the first BSS may perform first BSS beacons and groupcast signaling 322 on the primary channel 302. The first BSS beacons and groupcast signaling 322 can include DTIM beacons, non-DTIM beacons, and groupcast traffic the device associated with the first BSS sends to the first BSS clients 110. The device associated with the second BSS may exchange traffic with clients of the second BSS via second BSS traffic signaling 324 during the first BSS beacon period 320 on the secondary 20 channel 304 and the secondary 40 channel. The second BSS traffic signaling 324 can include traffic that the device associated with the second BSS would transmit to the second BSS clients 112 outside of a beacon period, such as latency sensitive traffic. Thus, the second BSS clients 112 may receive traffic without interruption during the second BSS beacon period 310.

The device associated with the first BSS can schedule and perform first BSS traffic signaling 314 for any subsequent second BSS beacon period 310. Similarly, the device associated with the second BSS can schedule and perform second BSS traffic signaling 324 for any subsequent first BSS beacon period 320. The devices can use C-OFDMA or pseudo-C-OFDM for the first BSS traffic signaling 314 and the second BSS traffic signaling 324.

FIG. 4 is a block diagram of a third signal process 400 for reducing latency of DL traffic using secondary channel access during beacon and groupcast traffic. The third signal process 400 may illustrate the signals exchanged between an AP (e.g., including VAPs) and clients with the x-axis variable being time and the y-axis variable being frequency. For example, the third signal process 400 may include the AP 102 transmitting beacons, groupcast traffic, and other traffic during beacon periods. The y-axis includes the primary channel 302, the secondary 20 channel 304, and the secondary 40 channel 306.

During beacon periods, the AP 102 can transmit the beacons and groupcast traffic on the primary channel 302. Therefore, the secondary channels may be available for the AP 102 to transmit other traffic during beacon periods. The third signal process 400 illustrates the AP 102 utilizing the secondary channels for other traffic during beacon periods.

The third signal process 400 may begin with DL policy signaling 402. The AP 102 may perform the DL policy signaling 402 to establish a policy with its clients (e.g., the first BSS clients 110, the second BSS clients 112, and/or the like) that the AP 102 may send DL traffic on secondary channels during beacon periods. If the AP 102 requires Acknowledgements (ACKs) in response to the DL traffic, the AP 102 can receive the ACKs via UL signals after a beacon period. The DL policy signaling 402 may occur during a traffic period 210, when the AP 102 starts or is otherwise initialized, when a client associates with the AP 102, be advertised periodically, and/or the like.

The third signal process 400 may also include primary channel modification signaling 404. The AP 102 may optionally perform primary channel modification signaling 404 to indicate to one or more clients to temporarily change their primary channel to a different channel for an upcoming beacon period. Alternatively, the AP 102 may use the primary channel modification signaling 404 to indicate to one or more clients the one or more secondary channels the AP 102 will use for DL traffic. The primary channel modification signaling 404 may be performed using Subchannel Selective Transmission (SST), using a modified Multi-User Request to Send (MU-RTS), as a default exception to a Restricted Target Wait Time (RTWT) agreement, or another policy (e.g., if QoS traffic priority beats beacon priority, look to non-primary channels during the beacon period for the QoS traffic, etc.).

During a DL capable beacon period 405, the AP 102 can perform beacon and groupcast signaling 406 on the primary channel 302 and transmit DL traffic 408 on the secondary 20 channel 304 and the secondary 40 channel 306. The beacon and groupcast signaling 406 can include DTIM beacons, non-DTIM beacons, and groupcast traffic. The DL traffic 408 can include traffic the AP 102 transmits to one or more clients, for example to maintain latency requirements during the DL capable beacon period 405.

Adjacent-channel interference between the beacon and groupcast signaling 406 and DL traffic 408 can be lowered if the AP 102 uses pseudo-C-OFDM for the beacon and groupcast signaling 406 and DL traffic 408. In some embodiments, the AP 102 may send beacons of the beacon and groupcast signaling 406, especially beacons with critical updates, via a non-primary channel as well. For example, the AP 102 may send the beacons as part of an Aggregated Media Access Control Protocol Data Unit (AMPDU) at a high Modulation and Control Scheme (MCS) tuned to a specific recipient client so there may be extra available frames. In other embodiments, the AP 102 may send beacons with critical updates via non-High Throughput (HT) duplicate transmissions. Thus, the AP 102 can send beacons with critical updates via the primary channel 302 and secondary channels during the DL capable beacon period 405 to ensure clients receive the updates.

After the DL capable beacon period 405, ACK signaling 410 can occur. The AP 102 can receive ACKs (e.g., Block ACKs (BAS)) from the one or more clients that received the DL traffic 408. The third signal process 400 or portions of the third signal process 400 can repeat so the AP 102 can continue to send DL traffic 408 during subsequent DL capable beacon periods 405.

FIG. 5 is a block diagram of a fourth signal process 500 for reducing latency of UL and DL traffic using secondary channel access during beacon and groupcast traffic. The fourth signal process 500 may illustrate the signals exchanged between an AP (e.g., including VAPs) and clients with the x-axis variable being time and the y-axis variable being frequency. For example, the fourth signal process 500 may include the AP 102 transmitting beacons, transmitting groupcast traffic, transmitting other DL traffic, and receiving UL traffic during beacon periods. The y-axis includes the primary channel 302, the secondary 20 channel 304, and the secondary 40 channel 306.

To perform the fourth signal process 500, the AP 102 may be adjacent-channel full duplex capable, having the ability to transmit on the primary channel 302 and receive on one or more of the adjacent or nearby secondary channels (e.g., on the secondary 20 channel 304, on the secondary 40 channel 306, and/or the like. Thus, the AP 102 is capable of sending DL traffic and receiving UL traffic during a beacon period. The AP 102 can advertise the capability for UL and DL traffic during beacon periods via UL and DL policy signaling 502. The UL and DL policy signaling 502 can indicate to clients that UL and DL traffic will be exchanged on secondary channels during beacon periods. The UL and DL policy signaling 502 may occur during a traffic period 210, when the AP 102 starts or is otherwise initialized, when a client associates with the AP 102, be advertised periodically, and/or the like.

The AP 102 may perform primary channel modification signaling 404 to indicate to clients to modify their primary channel for an upcoming beacon period or otherwise know that UL and DL signaling will occur on one or more secondary channels during the upcoming beacon period. During a UL and DL capable beacon period 504, the AP 102 can perform beacon and groupcast signaling 406 on the primary channel 302 and exchange UL and DL traffic 506 via secondary channels (e.g., the secondary 20 channel 304, the secondary 40 channel 306, and/or the like). The UL and DL traffic 506 can include DL traffic the AP 102 determines to send to one or clients, UL traffic the AP 102 receives from one or more clients including any ACKs from clients, and/or the like.

Adjacent-channel interference between the beacon and groupcast signaling 406 and UL and DL traffic 506 can be lowered if the AP 102 uses pseudo-C-OFDM for the beacon and groupcast signaling 406 and UL and DL traffic 506. In some embodiments, the AP 102 may send beacons of the beacon and groupcast signaling 406, especially beacons with critical updates, via a non-primary channel as well. For example, the AP 102 may send the beacons as part of an AMPDU at a high MCS tuned to a specific recipient client so there may be extra available frames. In other embodiments, the AP 102 may send beacons with critical updates via non-HT duplicate transmissions. Thus, the AP 102 can send beacons with critical updates via the primary channel 302 and secondary channels during the UL and DL capable beacon period 504 to ensure clients receive the updates. The fourth signal process 500 or portions of the fourth signal process 500 can repeat so the AP 102 can continue to send UL and DL traffic 506 during subsequent UL and DL capable beacon periods 504.

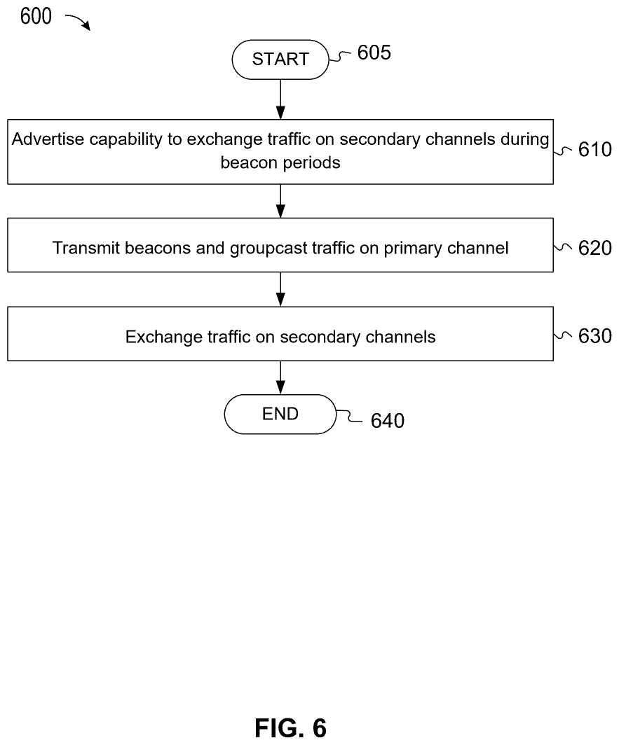

FIG. 6 is a flow chart of a method 600 for enabling secondary channel access during beacon and groupcast traffic. The method 600 may being at starting block 605 and proceed to operation 610. In operation 610, a capability to exchange traffic on secondary channels during beacon periods is advertised. For example, the AP 102 may advertise the capability to exchange DL traffic using the DL policy signaling 402 or otherwise indicate the capability to clients. Alternatively, the AP 102 may advertise the capability to exchange UL and DL traffic using the UL and DL policy signaling 502 or otherwise indicate the capability to clients. In some embodiments, the AP 102 also instructs one or more clients to switch primary channels during the beacon period or otherwise indicates to use the one or more secondary channels to exchange traffic during the beacon period.

In operation 620, beacons and groupcast traffic are transmitted on a primary channel. For example, the AP 102 may perform beacon and groupcast signaling 406 or otherwise transmit the beacons and groupcast traffic. The AP 102 may perform beacon and groupcast signaling 406 on a primary channel. The second AP 150 may determine that the AP 102 performs the beacon and groupcast signaling 406 on a primary channel in some example implementations.

In operation 630, traffic is exchanged with one or more clients on one or more secondary channels. For example, the AP 102 may transmit DL traffic 408 to the one or more clients. Alternatively, the AP 102 may perform UL and DL communication with the one or more clients. The traffic can include one or more beacons with updates (e.g., critical updates). The AP 102 can use C-OFDMA, C-OFDM, and/or pseudo-C-OFDM for the beacons and groupcast traffic and/or traffic on the secondary channels. In some embodiments, the AP 102 can receive acknowledgments from the clients after the beacon period when the AP 102 only sends DL traffic 408 to the clients.

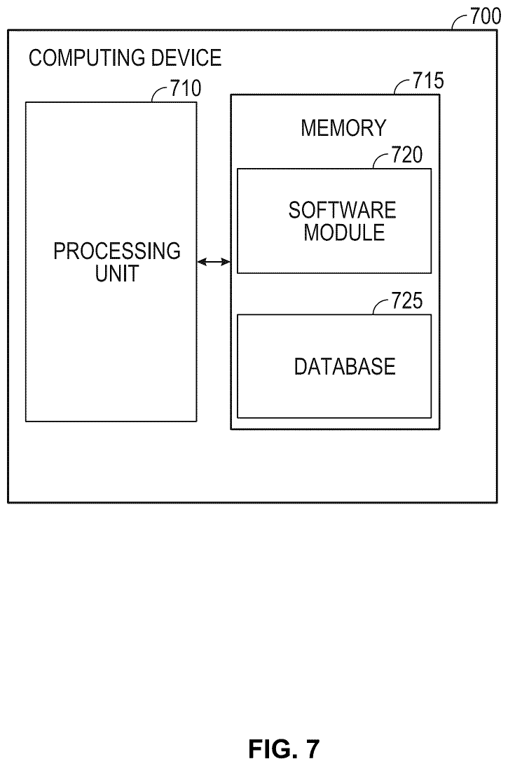

FIG. 7 is a block diagram of a computing device 700. As shown in FIG. 7, computing device 700 may include a processing unit 710 and a memory unit 715. Memory unit 715 may include a software module 720 and a database 725. While executing on processing unit 710, software module 720 may perform, for example, processes for secondary channel access during beacon and groupcast traffic and shortening beacon periods with respect to FIG. 1, FIG. 2, FIG. 3, FIG. 4, FIG. 5, and FIG. 6. Computing device 700, for example, may provide an operating environment for the AP 102, the first BSS clients 110, the second BSS clients 112, the controller 122, and the like. The AP 102, the first BSS clients 110, the second BSS clients 112, the controller 122, and the like may operate in other environments and are not limited to computing device 700.

Computing device 700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 700 may comprise any computer operating environment, such as hand-held devices, multiprocessor systems, microprocessor-based or programmable sender electronic devices, minicomputers, mainframe computers, and the like. Computing device 700 may also be practiced in distributed computing environments where tasks are performed by remote processing devices. The aforementioned systems and devices are examples, and computing device 700 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 700 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
advertising a capability to exchange traffic on secondary channels during beacon periods; and
during a beacon period:
transmitting beacons and groupcast traffic on a primary channel, and
one or more of transmitting and receiving traffic with one or more clients on one or more secondary channels.

2. The method of claim 1, wherein:
one or more of transmitting and receiving traffic with the one or more clients comprises transmitting Downlink (DL) traffic to the one or more clients on the one or more secondary channels.

3. The method of claim 2, further comprising:
receiving one or more Acknowledge (ACK) signals from the one or more clients after the beacon period in response to transmitting the DL traffic.

4. The method of claim 1, wherein:
one or more of transmitting and receiving traffic with the one or more clients comprises any one of (i) transmitting DL traffic to the one or more clients on the one or more secondary channels, (ii) receiving Uplink (UL) traffic from the one or more clients, or (iii) a combination of (i) and (ii).

5. The method of claim 1, wherein transmitting the beacons and groupcast traffic on the primary channel, and exchanging traffic with the one or more clients on the one or more secondary channels comprises using any one of: (i) Coordinated-Orthogonal Frequency-Division Multiple Access (C-OFDMA), (ii) Coordinated-Orthogonal Frequency-Division Multiplexing (C-OFDM), or (iii) pseudo-C-OFDM.

6. The method of claim 1, further comprising:
instructing the one or more clients to switch primary channels during the beacon period or indicating to use the one or more secondary channels to exchange traffic during the beacon period.

7. The method of claim 1, further comprising:
offsetting a plurality of Virtual APs (VAPs) to reduce the number of VAPs that will send DTIM beacons and groupcast traffic per beacon period.

8. A system comprising:
a memory storage; and
a processing unit coupled to the memory storage, wherein the processing unit is operative to:
advertise a capability to exchange traffic on secondary channels during beacon periods; and
during a beacon period:
transmit beacons and groupcast traffic on a primary channel, and
one or more of transmit and receive traffic with one or more clients on one or more secondary channels.

9. The system of claim 8, wherein:
to one or more of transmit and receive traffic with the one or more clients comprises to transmit DL traffic to the one or more clients on the one or more secondary channels.

10. The system of claim 9, the processing unit being further operative to:
receive one or more ACK signals from the one or more clients after the beacon period in response to transmitting the DL traffic.

11. The system of claim 8, wherein:
to one or more of transmit and receive traffic with the one or more clients comprises any one of (i) to transmit DL traffic to the one or more clients on the one or more secondary channels, (ii) to receive UL traffic from the one or more clients, or (iii) a combination of (i) and (ii).

12. The system of claim 8, wherein to transmit the beacons and groupcast traffic on the primary channel, and exchange traffic with the one or more clients on the one or more secondary channels comprises to use any one of: (i) Coordinated-Orthogonal Frequency-Division Multiple Access (C-OFDMA), (ii) Coordinated-Orthogonal Frequency-Division Multiplexing (C-OFDM), or (iii) pseudo-C-OFDM.

13. The system of claim 8, the processing unit being further operative to:
instruct the one or more clients to switch primary channels during the beacon period or indicate to use the one or more secondary channels to exchange traffic during the beacon period.

14. The system of claim 8, wherein to exchange traffic with the one or more clients on the one or more secondary channels comprises to transmit a beacon with an update on the one or more secondary channels.

15. A non-transitory computer-readable medium that stores a set of instructions which when executed perform a method executed by the set of instructions comprising:
advertising a capability to exchange traffic on secondary channels during beacon periods; and
during a beacon period:
transmitting beacons and groupcast traffic on a primary channel, and
one or more of transmitting and receiving traffic with one or more clients on one or more secondary channels.

16. The non-transitory computer-readable medium of claim 15, wherein:
one or more of transmitting and receiving traffic with the one or more clients comprises transmitting DL traffic to the one or more clients on the one or more secondary channels.

17. The non-transitory computer-readable medium of claim 16, the method executed by the set of instructions further comprising:
receiving one or more Acknowledge (ACK) signals from the one or more clients after the beacon period in response to transmitting the DL traffic.

18. The non-transitory computer-readable medium of claim 15, wherein:
one or more of transmitting and receiving traffic with the one or more clients comprises any one of (i) transmitting DL traffic to the one or more clients on the one or more secondary channels, (ii) receiving UL traffic from the one or more clients, or (iii) a combination of (i) and (ii).

19. The non-transitory computer-readable medium of claim 15, wherein transmitting the beacons and groupcast traffic on the primary channel, and exchanging traffic with the one or more clients on the one or more secondary channels comprises using any one of: (i) Coordinated-Orthogonal Frequency-Division Multiple Access (C-OFDMA), (ii) Coordinated-Orthogonal Frequency-Division Multiplexing (C-OFDM), or (iii) pseudo-C-OFDM.

20. The non-transitory computer-readable medium of claim 15, the method executed by the set of instructions further comprising:
instructing the one or more clients to switch primary channels during the beacon period or indicating to use the one or more secondary channels to exchange traffic during the beacon period.
